(19) United States
(12) Patent Application Publication
(10) Pub. No.: US 2025/0146327 A1
(43) Pub. Date: May 8, 2025

(54) Bolting Mechanism

(71) Applicant: Surelock McGill Ltd., Wokingham (GB)

(72) Inventors: Alon Dawe, Olst (NL); Adam Lambourn, Reading (GB)

(21) Appl. No.: 18/938,827

(22) Filed: Nov. 6, 2024

(30) Foreign Application Priority Data
Nov. 8, 2023 (GB) 2317140.8

(51) Int. Cl. E05B 47/00; G07C 9/00

(52) U.S. Cl. CPC E05B 47/0012; G07C 9/0069

(57) ABSTRACT

A bolting mechanism includes a bolt movable between positions, a drive for bolt retraction and configured to be driven by a handle, a mechanical code lock having a key pad for receiving a code, and a controller configured to enable the code lock such that the code lock enables actuation of the drive by the handle on entry of a matching code. The mechanism further includes a deadbolt mechanism arranged to prevent the bolt from being driven by the handle when in the locked state. The deadbolt mechanism comprises an actuator for releasing the deadbolt when a signal is received from an access control unit, and a second controller for releasing the deadbolt on actuation by a matching key. The drive is configured to release the handle for driving the bolt to the retracted position when enabled by the mechanical code lock and the deadbolt mechanism releases the deadbolt mechanism.

### RELATED APPLICATIONS

This application claims priority to United Kingdom application number 2317140.8, filed Nov. 8, 2023, the disclosure of which is incorporated herein by reference in its entirety.

### TECHNICAL FIELD

The present invention relates to a bolting mechanism for securing a door or leaf. The bolting mechanism may be a multi-point bolting mechanism with access control by powered electrical and unpowered mechanical means.

### BACKGROUND

Electrically or electronically controlled means of controlling access through doors are known and provide various different levels of access depending on requirements. For example, a magnetic lock may comprise an electromagnet and be fixed to a door frame. When the electromagnet is powered the door is secured closed by the electromagnetic attracting a ferromagnetic plate attached to the door. Access may be controlled simply by powering the electromagnet at times when access is not allowed and removing power from the electromagnet when access is permitted. Such a system may be connected to an electronic access control system which allows access when a swipe card or fob is presented at a card reader, or when a numeric code is entered into an electronic keypad. However, such systems rely on power being available to provide security and are normally set to have free-escape such that doors are released in the event of power failure or power being removed.

Some situations require the functionality of an electronic access control system but are environments where power is intermittent, such as building sites. Other circumstances may require the deliberate removal of power. For example, for religious reasons it may be desirable to turn off electronic and electrical devices on the sabbath. In such cases the use of conventional electronic access control systems is problematic because doors are generally unsecured and released when power is removed.

To control access when power is not continuously available, multiple doors may be provided. A first door may have a handle driven latch which also has a key controlled lock. When it is desired to use this door, the lock in unlocked by the key and persons can pass through the door freely. In other times only those with a key can use the door. A second door to the same building or room may be provided, for example, following the first door such that to enter the building a person has to pass through both doors. The second door may have electronic access control. The opening of the second door may be limited to those with a swipe card or who know the access code. Hence, access may be controlled to particular individuals. When power is removed or turned off, access is controlled by the latch and key of the first door. If it is desired to limit entry to particular individuals then each individual will need to be provided with a key. This may be undesirable especially if the number of individuals that are to be granted access is more than a few.

In other circumstances two doors may provide separate access to a building or room, such as shown in FIG. 1. One door may have electronic access control and the other may be secured with a key cylinder. On sabbath days the key cylinder is unlocked to allow many people to enter freely. The electronic access control may be implemented in a fail-secure manner such that when power is removed the door remains secured. Hence, on sabbath days when power is turned off the electronically controlled door remains secured. On non-sabbath days access would be limited to those having a key card, those who know the access control code or those having a key for the key cylinder.

In each of the above configurations it would be desirable to use a single door for times when power is available and when it is not, and when power is available to be able to use the additional functionality provided by electronic access control.

### SUMMARY OF THE INVENTION

The present invention provides a bolting mechanism comprising: one or more bolts movable between thrown and retracted positions; a drive mechanism configured for retracting the bolt, the drive mechanism configured to be driven by a first handle or lever from a first side; a mechanical code lock having a key pad for receiving an entry code; and a first key actuated controller, such as a key cylinder, configured to enable and disable the mechanical code lock such that when the mechanical code lock is enabled the mechanical code lock, on entry of a correct or matching code to the key pad, enables actuation of the drive mechanism by the first handle; a deadbolt mechanism comprising a deadbolt arranged to prevent the bolt from being driven by the first handle or lever when the deadbolt is in the locked state, the deadbolt mechanism comprising: an electrical actuator configured to release the deadbolt from the locked state when a release signal is received from an electrical or electronic access control unit; and a second key actuated controller, such as a second key cylinder configured to release the deadbolt from the locked state on actuation by a matching key, wherein the drive mechanism is configured such that, when enabled by the mechanical code lock, and the deadbolt is released by the deadbolt mechanism, the first handle or lever is released for driving the bolt to the retracted position. Accordingly, a bolting mechanism is provided with the mode of operation controlled by two key cylinders, in one mode the bolting mechanism is released by the electronic access control unit and in another mode the bolting mechanism is released by the mechanical code lock. The key cylinders may also set additional modes of operation. At least the mechanical code lock and first and second cylinders may be provided together in one housing for mounting to a door or leaf.

The drive mechanism may have a second side configured to receive a second lever or handle, and the drive mechanism may be configured to be driven by the second lever or handle to override the deadbolt and drive the bolt to the retracted position.

The first side of the bolting mechanism may be configured for driving on a first side of the door or leaf. The second side of the bolting mechanism may be configured for driving on a second, opposing side of the door or leaf.

The first key actuated controller and the second key actuated controller may be configured to receive mechanical keys at the first side of the drive mechanism, and the mechanical code lock is arranged to receive entries on the key pad at the first side of the drive mechanism. The first key actuated controller may be actuated on receipt of a first matching key. The second key actuated controller may be actuated on receipt of a second, preferably different, matching key.

The first key actuated controller and second key actuated controller may be key cylinders.

The key pad may be located at the first side of the drive mechanism between the first key actuated controller and the second key actuated controller.

The first key actuated controller may be configured to enable a code change mode on the mechanical code lock for changing the code enabling actuation of the drive mechanism by the first handle or lever, wherein the code change mode enabled on receiving and rotating a matching key.

The first key actuated controller may comprise a first key cylinder, and the bolting mechanism may further comprise: an activation plate configured to slide between an activated position in which the key pad is active for receiving input of an entry code and operably releasing the first handle, and an inactive position in which the key pad is decoupled from control of the handle; and a cam coupled to the first key cylinder, the cam configured such that on receipt and rotation of a matching key by the first key cylinder the cam drives the activation plate between the activated position and inactive position. In the inactive position the decoupling of the key pad from the first handle may result in the first handle being free to operate. In this position the buttons of the key pad may also be locked and may be unable to be depressed. Lockout of the keypad and maintaining of lockout by the position of the key cylinder means that buttons cannot be inadvertently pressed releasing lockout as is the case for some prior art devices. Prior art devices do not provide both locking of the key pad and release of the handle on turning of a single key.

The cam may be configured for rotation to a change position enabling the change code mode in which the cam may push against a change member enabling changing of the correct entry code for the key pad. The cam may include, at least in part, a spiral surface having first and second diameters at a given radius, such that at the first diameter (no rotation) the cam is configured to set the activation plate in a rest position in which the key pad is active and at the second diameter (360 degrees rotation) the cam pushes the activation to the inactive position.

The bolting mechanism as described herein, wherein: the second key actuated controller may comprise a second key cylinder; and the deadbolt of the deadbolt mechanism may be a sliding deadbolt configured to slide between a locked position in which the sliding deadbolt inhibits retraction of the bolt and one or more unlocked positions.

The electrical actuator of the deadbolt mechanism may be configured to retract the sliding deadbolt to one of the one or more unlocked positions on application or removal of power to the electrical actuator.

The deadbolt mechanism may further comprise: a release driver arranged such that, when driven by the second key cylinder, the release driver retracts the sliding deadbolt to one of the one or more unlocked positions; and a latch configured to hold the sliding deadbolt in one of the one or more unlocked positions until the release driver is further driven by the key cylinder to release the sliding deadbolt.

The release driver may be a rotatable cam or tang of the second key cylinder.

The sliding deadbolt may comprise a locking portion configured for inhibiting retraction of the bolt and a latch portion configured to be held by the latch in the one of the one or more unlocked positions, the latch portion may be slidable with lost motion relative to the locking portion.

The electrical actuator may be configured to retract the locking portion of the sliding deadbolt to a first of the one or more unlocked positions. A release driver may be arranged such that, when driven by the second key cylinder, the release driver retracts the latch portion of the sliding deadbolt to the first or a second of the one or more unlocked positions. The latch may be configured to hold the latch portion of the sliding deadbolt in the second of the one or more unlocked positions until the release driver is further driven by the key cylinder to release the sliding deadbolt

The present invention further provides a bolting mechanism kit, comprising any of the bolting mechanisms described herein and further comprising an electrical access control device configured for mounting on or next to a first side of the door or leaf.

The present invention provides a bolting mechanism comprising: a bolt movable between a thrown position and a retracted position; a drive mechanism configured for retracting the bolt, the drive mechanism configured to be driven by a first handle from a first side; a mechanical lock configured for releasing and preventing retraction of the bolt; an electrically activated lock configured for releasing and preventing retraction of the bolt; and one or more mechanical controllers configured to select whether the mechanical lock is configured for release and whether the electrically activated lock is configured for release, the one or more mechanical controllers operable to select on provision of a secure key. The mechanical lock may be the mechanical code lock described herein. The electrically activated lock may be the deadbolt mechanism described herein, including the electrical actuator. The one or more mechanical controllers may be first and second key actuated controllers or first and second key cylinders.

The present invention further provides a code lock for controlling access through a door/leaf, the code lock configured to be inactivated on action of a key cylinder, the code lock comprising: a key pad for receiving an entry code; a handle for retracting a bolt or latch of the door or leaf, the handle configured to be operable upon entry of the correct entry code to the key pad; the key cylinder; an activation plate configured to slide between an activated position in which the key pad is active for receiving input of an entry code and operably releasing the handle, and an inactive position in which the key pad is decoupled from control of the handle; and a cam coupled to the key cylinder, the cam configured such that on receipt and rotation of a matching key by the key cylinder the cam drives the activation plate between the activated position and the inactive position. In the inactive position the decoupling of the key pad from the first handle may result in the first handle being free to operate. In this position the buttons of the key pad may also be locked and may be unable to be depressed. Lockout of the keypad and maintaining of lockout by the position of the key cylinder means that buttons cannot be inadvertently pressed releasing lockout as is the case for some prior art devices. Prior art devices do not provide both locking of the key pad and release of the handle on turning of a single key.

The cam may be configured for rotation to a change position in which the cam pushes against a change member enabling changing of the correct entry code for the key pad.

The present invention further provides a lock mechanism, comprising: a bolt movable between a thrown position and a retracted position; and a deadbolt mechanism. The deadbolt mechanism comprises: a sliding deadbolt configured to slide between a locked position in which the sliding deadbolt inhibits retraction of the bolt and one or more unlocked positions; an electrical actuator configured to retract the sliding deadbolt to one of the one or more unlocked positions on application or removal of power to the electrical actuator; a release driver arranged such that, when driven by a key cylinder, the release driver retracts the sliding deadbolt to one of the one or more unlocked positions; and a latch configured to hold the sliding deadbolt in one of the one or more unlocked positions until the release driver is further driven by the key cylinder to release the sliding deadbolt.

The sliding deadbolt may comprise a locking portion configured for inhibiting retraction of the bolt and a latch portion configured to be held by a latch in one of the one or more unlocked positions. The latch portion may be slidable with lost motion relative to the locking portion.

The release driver may be a tang or cam of the key cylinder.

### BRIEF DESCRIPTION OF THE DRAWINGS

Embodiments of the present invention, and aspects of the prior art, will now be described with reference to the accompanying drawings, of which:

FIG. 1 is a schematic diagram showing two doors providing separate access to a building or room, with one door having electronic access control and the other secured with a key cylinder;

FIGS. 2A and 2B are perspective views of two sides or a door having mounted thereon a bolting mechanism, wherein FIG. 2A is a view of a side of a door on the outside of a building and FIG. 2B is a view of the side of the door on the inside of the building;

FIGS. 3A and 3B are detailed plan views of the first and second parts or sides of the bolting mechanism respectively with FIG. 3B shown in a partial cutaway view revealing internal components of the bolting mechanism;

FIGS. 4A-4C are three perspective drawings of the first part of the bolting mechanism such as for mounting on the outside of the door;

FIG. 5 is a rear plan view of the first part of the bolting mechanism 100a and outside handle;

FIGS. 6A, 6B, and 6D are detailed plan views of the rear of the first part of the bolting mechanism showing the interaction between the cam, activation plate and change member for the three modes of operation of the mechanical code lock;

FIG. 6C is a partial enlarged view of the bolting mechanism shown in FIG. 6B;

FIG. 7 is a schematic diagram linking the two key cylinders 130, 140 and outside handle 110 on a first of the door with the deadbolt mechanism 300, a drive mechanism 440 and inside handle 210 on a second side of the door;

FIGS. 8A and 8B are plan views of the second drive train and first drive train of the bolting mechanism;

FIGS. 9A, 9C, and 9D are enlarged plan views of the deadbolt mechanism respectively showing the deadbolt in a locked position and in a retracted position retracted by electrical actuator or manual override, and retracted by key cylinder;

FIG. 9B is a partial enlarged view of the bolting mechanism shown in a partial cutaway view revealing internal components of the deadbolt mechanism shown in FIG. 9D;

FIG. 9E is a partial enlarged view of the bolting mechanism shown in a partial cutaway view revealing internal components of the deadbolt mechanism shown in FIG. 9A;

FIGS. 10A and 10B are enlarged plan views of the deadbolt mechanism showing an alternative operation for retracting the deadbolt using the key cylinder without latching the sliding deadbolt in the retracted position;

FIG. 11 is a table summarizing the operating modes of the bolting mechanism; and

FIG. 12 is a flow chart summarizing operation of the bolting mechanism.

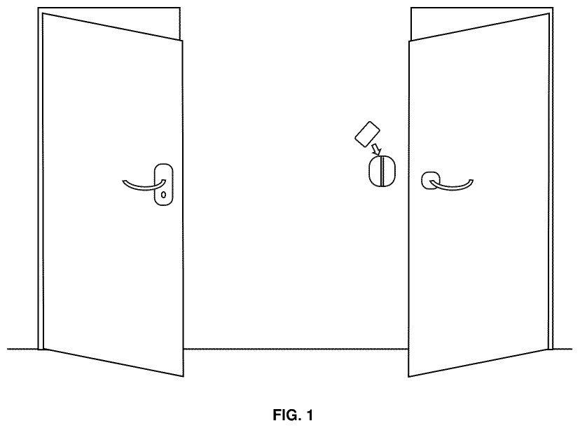

### DETAILED DESCRIPTION

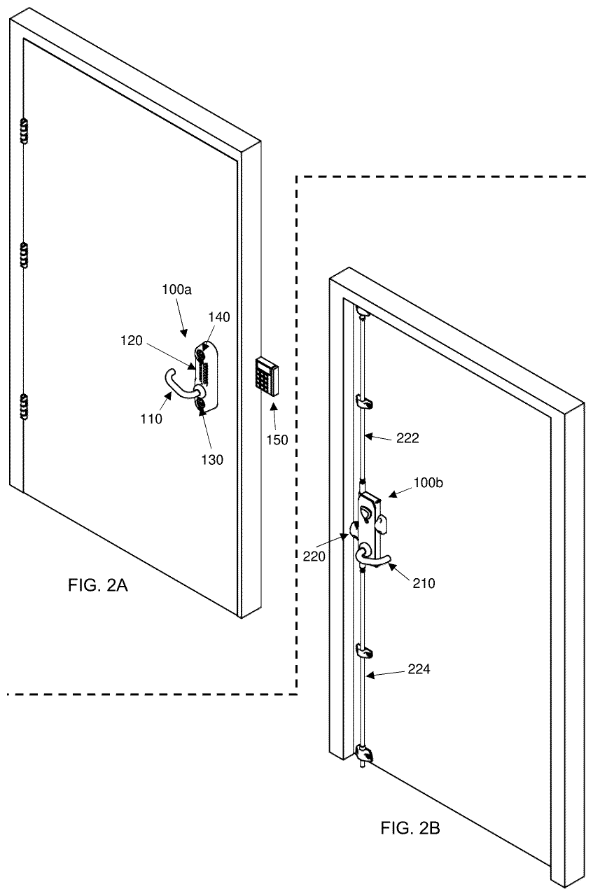

FIGS. 2A and 2B are perspective views of a door having mounted thereto a bolting mechanism according to embodiments of the present invention. FIG. 2A is a view of a side of a door that may be on the outside of a building or to the outside of a room or space which it is desired to limit access into. FIG. 2B is a view of the other side of the door, which may on the inside of a building, room or space, that is being secured. The dashed line between the two figures is provided for clarity to define limits to the inside figure and outside figure.

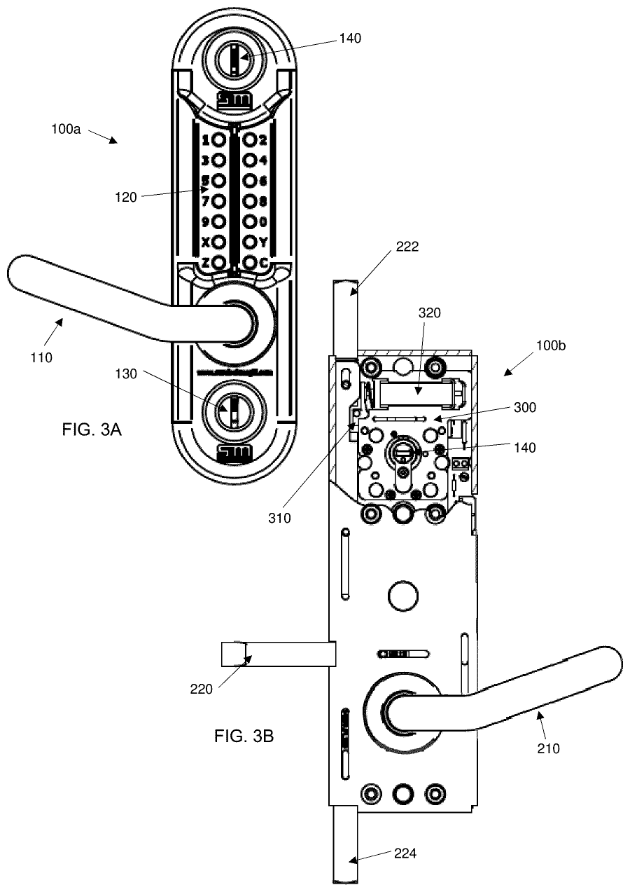

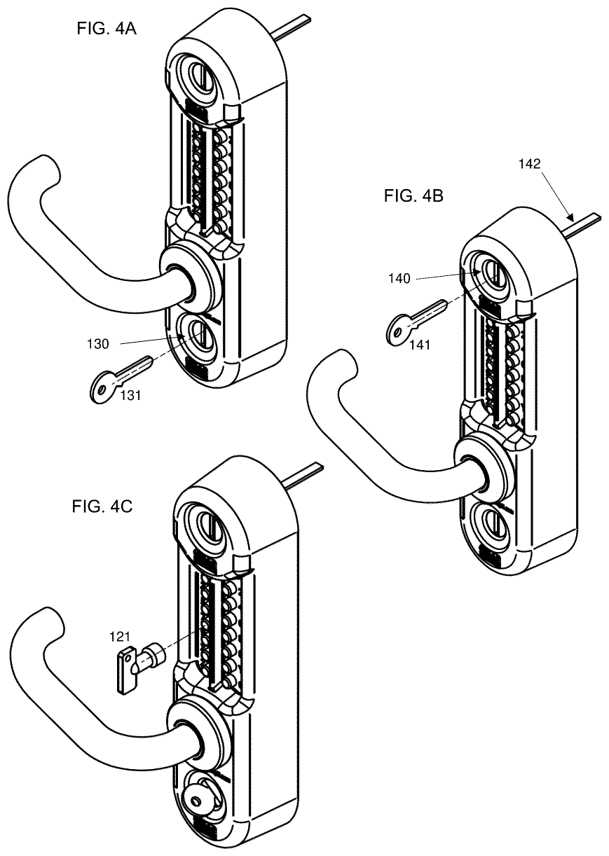

As shown in FIG. 2A, the door is opened and closed from a first side, such as the outdoor side or outside, by a handle 110 which forms part of bolting mechanism. On the first side of the door can be seen first side or first part 100a of the bolting mechanism. Operation of the handle 110 is controlled by other parts of the bolting mechanism, including mechanical key pad 120, first key cylinder 130, second key cylinder 140 and also electronic access control unit 150, many of which are shown in more detail in FIGS. 3 and 4. Electronic access control unit 150 may be mounted separately to the bolting mechanism such as to the wall adjacent to the door. FIG. 2B shows the second side of the door, such as the indoor side or inside. On this side of the door a second side or second part 100b of the bolting mechanism may be provided. Alternatively, the first and second parts may be combined on one side but actuated from the two sides. This second side or second part may also comprise a handle, indicated by 210. Together the parts 100a, 100b, on the two sides of door make up the bolting mechanism. In FIG. 2B, the bolting mechanism is shown to be a multi-point bolting mechanism comprising three bolts, namely: an upper vertical bolt 222 for securing a top of the door such as to the top of the door frame, a lower vertical bolt 224 for securing a bottom of the door against the floor, and a horizontal bolt (not shown but located at position 220) for securing the opening edge of the door against the side of the door frame. In other embodiments the bolting mechanism may include more or less bolts. For example, only a single bolt such as horizontal bolt may be provided, or alternatively two or more than three bolts may be provided and driven by the bolting mechanism to secure the door.

FIGS. 3A and 3B are plan views showing more details of the first and second parts or sides of the bolting mechanism. FIG. 3A is a plan view of the first part of the bolting mechanism. The handle 110 can be seen along with the mechanical key pad 120, first key cylinder 130 and second key cylinder 140. The first key cylinder 130 and second key cylinder are located at opposing ends of the first part of the bolting mechanism, with the handle 110 and mechanical key pad in between them. In the arrangement shown the handle is located below the mechanical key pad. The mechanical key pad 120 forms part of a mechanical code lock. Mechanical code locks which require entry of a correct numeric or alphanumeric code to release a handle to open a door are well known. However, as we will describe herein the mechanical code lock here is integrated differently to such known locks. The arrangement includes first and second key cylinders 130, 140. However, other key actuated controllers that are actuated by a mechanical key may be used instead but key cylinders are preferred.

The first key cylinder 130, shown in FIG. 3A below the handle and mechanical key pad 120, is a key cylinder for controlling operation of the mechanical key pad. On insertion and turning of a matching key into the key cylinder 130, the mechanical key pad can be switched between
i) a first mode in which the mechanical code lock controls operation of the handle 110;
ii) a second mode in which the mechanical code lock does not control operation of the handle 110 and the mechanical code lock either does not operate or has no effect on the handle; and
iii) a third mode, which is a change mode, in which the correct code to be entered may be changed for releasing the handle when the first mode is operational.

Further details on how this is achieved are described in the following. However, returning to FIG. 3A, second key cylinder 140 is shown above the mechanical keypad. Second key cylinder 140 controls operation of a deadbolt mechanism 300 which forms part of the second part of the bolting mechanism 100b on the inside side of the door, which is shown in FIG. 3B. As mentioned, although we describe this second part 100b of the bolting mechanism as provided on the second side of the door, in other embodiments it may be provided together with the first part 100a of the bolting mechanism on the first side of the door.

In FIG. 3B the second handle 210 is shown. Also shown are the three bolts 220, 222 and 224 of the multi-point bolting system. In other embodiments the bolts may each be formed of multiple pieces. For example, the bolts may not extend from the edges of the door to the bolting mechanism and, instead, push rods may extend from the bolting mechanism joining to more substantial bolts at the edges of the door. The cut-away portion of FIG. 3B shows deadbolt mechanism 300 which comprises a deadbolt 310 for blocking movement of the bolt or multi-point bolts, 220, 222, 224. The deadbolt 310 is actuated by second key cylinder 140, part of which can be seen in the cut-out section. The deadbolt 310 may also be actuated by an electrical or pneumatic actuator. In FIG. 3B a solenoid 320 is shown as an electrical actuator for actuating the deadbolt. The deadbolt may also be mechanically overridden when inside handle 210 is operated. We will describe in more detail these various aspects.

FIGS. 4A-4C are three perspective drawings of the part of the bolting mechanism that has many of the access control features and is therefore for mounting on the outside of the door. This is the first part of the bolting mechanism, as shown in FIG. 3A, and may be considered to be the outside handle assembly. FIG. 4A shows a mechanical key 131 ready for insertion into the first key cylinder 130 which is used for controlling operation of the mechanical code lock. FIG. 4B shows a mechanical key 141 ready for insertion into the second key cylinder 140 which is used for controlling operation of the deadbolt mechanism. FIG. 4C shows a change code tool 121 that is used for selecting buttons of the mechanical code lock in code change mode when it is desired to change the code that allows activation of the handle 110 for operation.

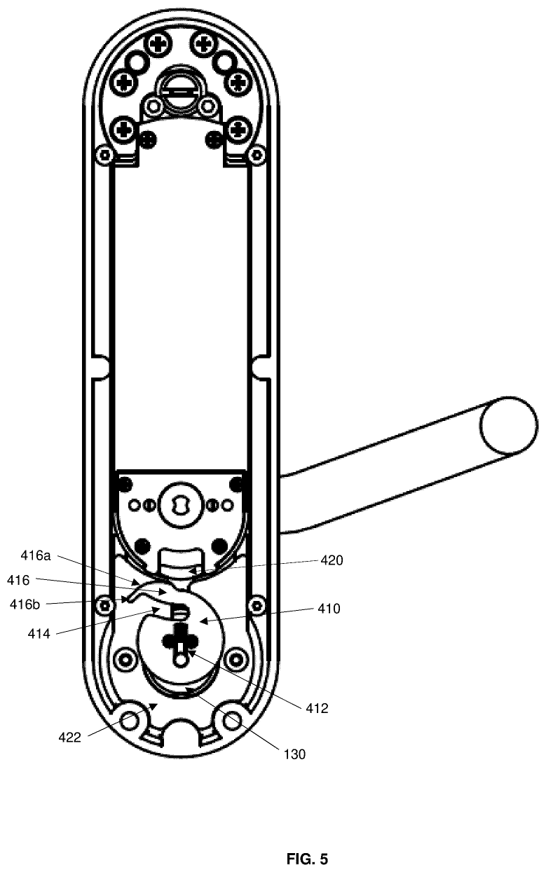

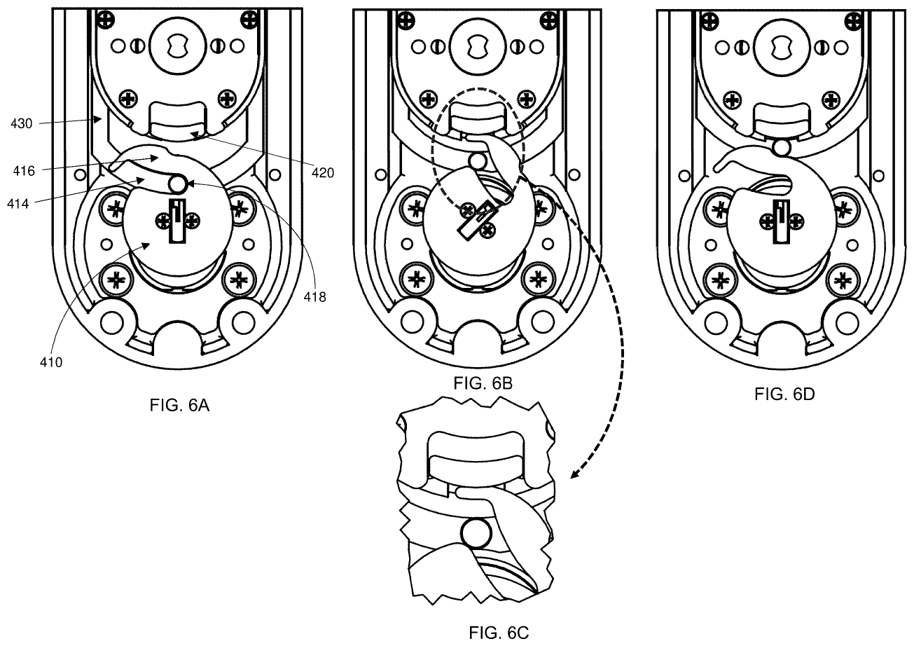

FIG. 5 shows the rear of the first part of the bolting mechanism 100a or outside handle assembly. Many aspects relating to the mechanical key code lock are conventional. However, aspects of the present invention are directed to the interaction with the first key cylinder 130, which as described above allows the mechanical code lock to be switched between three modes. In FIG. 5 the rear of the first key cylinder 130 can be seen. The first key cylinder may have a tailpiece that locates in a slot 412 in cam 410. Cam 410 is shaped to also include an open-ended slot or mouth 414 in its outer edge and to include a finger 416 that extends the outer edge of the cam away from a rotation axis. The finger may have a lobe portion 416a extending further away from the axis. The outer diameter of the cam, such as including a lot, finger and lobe, may have an increasing diameter and a path that, at least partly, overlaps spiralling outwards. For this reason the cam 410 may be called a snail cam. The slot 414, finger 416 and lobe 416a interact with a pin 418 and change member 420 of the mechanical key code lock, which are shown in more detail in FIGS. 6A-6D. The change member 420 may be a push-block as shown in the figures. In FIG. 5 the pin 418 and features of mechanical code lock are hidden by plate 422 which is not present in FIGS. 6A-6D.

Conventional mechanical code locks require disassembly to change the code. For example, behind each of the buttons is a wafer that has a notch cut out of it. When a button is pressed the wafer is pushed in and the position of the notch moves with it. When the correct buttons are pressed the notches in all of the wafers align and a blocking bar or plate is free to move allowing a handle to be rotated to release the lock. For buttons that do not form part of the code the notch is positioned differently on the wafer to that of the buttons forming the code. The non-code buttons have a notch that aligns with the blocking bar or plate when the button is not pressed. However, pressing a non-code button moves the notch out of position such that blocking bar or plate is blocked. Such conventional mechanical code locks require disassembly to change the correct code because this requires either the wafers to be turned around to swap the notch positions or non-code wafers are swapped with code wafers having differently positioned notches.

The mechanical code lock shown in FIGS. 6A-6D is configured for changing the code without having to disassemble the key code lock. In FIG. 6A pin 418 is received in the slot or mouth of the cam 414. The pin is part of activation plate or slide plate 430. With the activation plate in the position shown in FIG. 6A, that is, the activation plate is in the lowered position, the activation plate 430 sets the buttons of the key code lock as active. By entering the correct code at the buttons the code releases the handle 110 and entry through the door is permitted.

As shown in FIG. 6B the key cylinder may be rotated which results in rotating the cam 410. Before the key cylinder 130 may be rotated the correct key code must be entered to allow the activation plate 430 and pin 418 to move. Hence, entering the correct key code releases the activation plate 430 which releases the handle 110 and the cam 410 for turning. In some embodiments it is not necessary to enter the correct key code but simply that the cancel or “C” button is pressed to reset the wafers/buttons to start positions before turning the key.

FIGS. 6B and 6D show two positions of the cam after different amounts of rotation. To recap, the cam 410 is turned by key cylinder 130 after insertion of a matching mechanical key 131 and, as discussed above, after entry of the correct code to the key code lock 120 (or pressing the cancel or “C” button). In the position shown in FIG. 6B the key cylinder 130 and cam 410 have been rotated 45 degrees, whereas in FIG. 6D they have been rotated a full 360 degrees. As best shown in the partial enlarged view of FIG. 6C the rotation by 45 degrees pushes the pin 418 to the edge of the slot and the end of the finger is pushing against the change member or push-block 420. In this position the code may be changed. The finger 416 is pushing the push-block upwards. This pushes a bar or block upwards releasing the buttons of the key code lock for rotation. As shown in FIG. 4C a change code tool 121 may be used on the buttons to change the code. The change code tool is pushed on to each button. By turning the tool and button 180 degrees a button can be swapped from being a button that forms part of the code to a button that does not form part of the code, and vice versa. The wafers behind each button have two sides. On the one side the notch is cut in the wafer in a position such that the button needs to be pressed to release the lock. On the other side the notch is cut such that pushing of the button blocks release of the lock but without the button being pressed the positioning of the notch permits release of the lock.

We now describe the components of the mechanical code lock in more detail. Although we have described that behind each button may be a wafer, in embodiments the wafers may have a cylindrical body with a tail or tab at one end. The tail may engage in the back of the button. Rotation of the button rotates the tail and rotates the wafer. The cylindrical body may make rotation of the body easier. The body has the two notches as described previously, on opposite sides of the body. When oriented one way around the button is part of the code because the notch aligns correctly when pressed. In the other orientation the button is not part of the code because the button does not need to be pressed to have the notch align for release. The button may include a detent cam which may be a generally circular or elliptical shape with cam lugs on opposing sides of the cam. The detent cam sits in a recess or profiled hole in a plate. The plate is linked to the change member 420 which may be a push block. The circumference of the recess has a notch for receiving one of the cam lugs. When the plate is lifted the detent cam is allowed to rotate 180 degrees. Release of the plate or change member 420 causes the plate to drop locking the cam in position because one of the cam lugs is held in the notch in circumference of the recess in the plate. This arrangement allows rotation of the buttons and wafers to change the code for the key code lock. The buttons may be rotated by the code change tool 121. The tool 121 engages on the buttons or grips the buttons by friction or based on the shape of the buttons. In one embodiment, the buttons are circular and the tool has a rubber contact face and uses friction to grip and rotate the buttons. In another embodiment the buttons are an oval or elliptical in shape and the tool is shaped to be a close fit on the buttons. The buttons are symmetric so that it is not possible to detect which buttons have been rotated and are buttons forming the code, and which are not. For example, a single flat in the shape of the button could not be used but a pair of symmetrically opposed flats could be used. After the code has been changed the key cylinder can be rotated back 45 degrees returning the cam 410, pin 418 and activation plate 430 back to the position shown in FIG. 6A.

FIG. 6D shows the position of the cam 410, pin 418 and activation plate 430 after turning a further 315 degrees that is to a total of 360 degrees. To turn the cam the full 360 degrees the key code is required to be entered. During the 60 degree rotation the pin 418, after release from slot 414 in FIG. 6B, passes around the circumference of the cam 410 as the cam is rotated. As the cam 410 approaches a complete revolution the diameter of the cam pushing against the pin increases slightly such that as the cam reaches a full 360 degrees of rotation the pin is pushed further upwards pushing the activation plate further upwards. In this position the activation plate 430 blocks operation of the buttons of the code lock and the key pad is inactive. The activation plate also releases the handle 110 such that its operation is not controlled by the key pad.

Returning to FIG. 6A, in the active state, the activation plate 430 is biased down and has a portion pressing onto a clutch of the handle. Rotating the handle wants to lift the activation plate 430. However, when the correct code has not been entered, the wafers prevent the plate from being lifted. As the plate is unable to lift, the handle cannot rotate. When the correct code is entered the notches in the wafers are aligned, the plate can lift and the handle is free to turn. To deactivate the keypad, the correct code is entered to allow movement of the activation plate. As discussed above, then the key cylinder 130 is turned 360 degrees to lift the plate using the cam 410. In the position shown in FIG. 6D, the plate is held in the upper position allowing the handle to rotate freely whilst the buttons are locked.

At the full rotation position shown in FIG. 6D, the cam includes a slight depression in the edge which provides a detent to hold the cam at the 360 degree rotation position. The detent also includes a step which blocks further rotation of the cam beyond the 360 degree rotation position. With the key cylinder rotated the full 360 degrees the key 131 may be removed from the key cylinder. Hence, the use of the key in the key cylinder allows the key pad to be locked in the active state or the inactive state. A further intermediate state is that of change of the code, but the key 131 cannot be removed in this state.

The activation plate 430 may be considered to have three positions, namely: a first, lowered position in which key pad is active; a second or intermediate position in which the key code may be changed; and a third, raised position in which the key pad is inactive and the handle (depending on the state of the deadbolt mechanism 300) is free to move.

As mentioned above, aspects of the key code lock are known in the prior art. The cam 410 or snail cam, pin 418, activation plate 430 and push block 420, which provide interaction between the key cylinder and key pad are considered not known in the prior art. As discussed, the cam 410 has a slot 412 which receives the tailpiece or other rotatable part of the key cylinder when the matching key 131 is inserted and turned in the key cylinder 130. Key cylinder 130 is the key cylinder below the handle 110 and key pad 120. The cam 410 has a shape in which the radius from the centre to the edge increases and the edge has an overlap such that the edge may be considered to form a spiral or part of a spiral. As previously mentioned, the cam may have a finger 416 that extends the outer edge of the cam away from a rotation axis of the cam. The open-ended slot or mouth 414 extends under the finger. The slot 414 forms the inner part of the spiral of the edge and the finger 416 may form the outer parts of the spiral of the edge. The finger extends further to provide the pushing action against the push-block 420. The recess or detent is provided part way along this finger and may provide a stop preventing the pin 418 from travelling further along the edge of the cam as it is rotated. Hence, the stop prevents rotation of the cam and key cylinder by greater than 360 degrees. The slot or mouth has a path similar to a chord of a circle but starting from a centreline and extending to the edge in a curved path. The curved path may match the curved shape at the end of the activation plate 430 at which the pin 418 is located. As described, the finger 416 of the cam may have a lobe 416a towards an end of the finer on the one side. The other side of the finger forms one side of the slot or mouth 414. The end of the finger may have a guide tab 416b pointing away from the lobe to guide the pin 418 around the edge of the cam as the cam is initially turned from its rest position in which the key pad is active, shown in FIG. 6A. Over half of the cam may have a constant radius thereby taking a circular or semicircular form, with the slot or mouth and finger formed at the same one end of the cam 410.

When the key pad is in the inactive state, that is, with the activation plate 430 pushed up to its upper or inactive position, turning of the handle 110 is not blocked by the key code lock. In this mode other means of releasing the handle are required to be used.

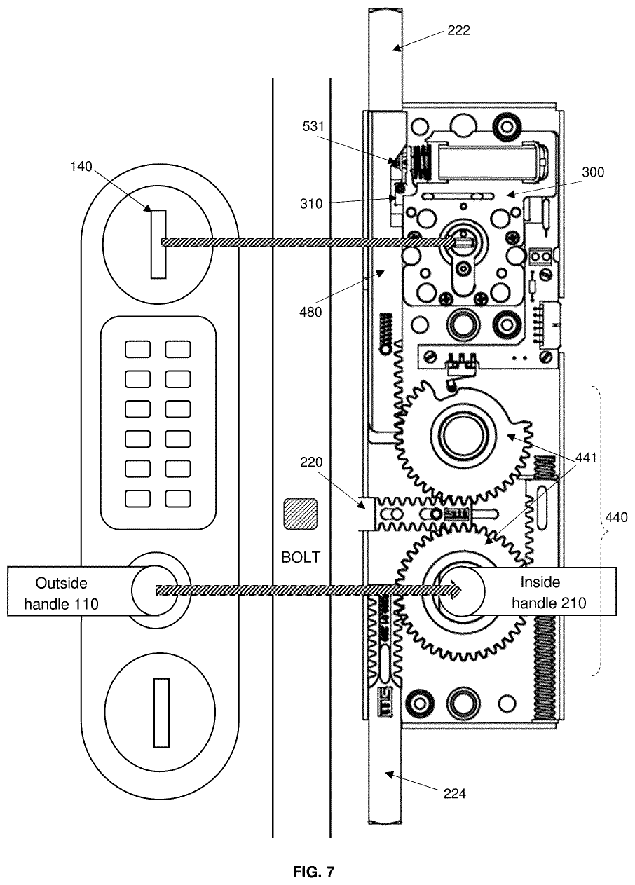

We now describe operation of the bolting mechanism using other release means such as the deadbolt mechanism 300 of FIG. 3B in combination with the key cylinder 140 of FIG. 4B and the handles. As shown in FIGS. 2, 3 and 4, the deadbolt mechanism may be mounted on the inside face of the door. Alternatively, the deadbolt mechanism may be mounted on the outer side of the door but is preferably mounted on whichever side of the door the bolts 220, 222, and 224 are provided. This is because the deadbolt mechanism has a deadbolt 310 that interacts with at least one of the bolts. In FIG. 3B the deadbolt 310 is shown thrown into a notch or cut-out in the bolt 222. FIGS. 7-10 show more detail of the deadbolt mechanism.

FIG. 7 schematically links the two key cylinders 130, 140 and outside handle 110 on the outside of the door with the deadbolt mechanism 300, a drive mechanism 440 and inside handle 210. As discussed above, the deadbolt mechanism 300 may be mounted on the inside or outside of the door. This also applies to the drive mechanism 440. Inside handle 210 is optional. However, for convenience of description we describe these features as shown in FIGS. 7-9.

As shown in FIG. 4B, key cylinder 140 maybe mounted on the outside of the door with the push button mechanical key code lock 120. The key cylinder 140 includes a tailpiece which extends through the door and into slot of a second part of the key cylinder or an extension to the key cylinder. Key cylinder 140 provides some control of the deadbolt of deadbolt mechanism.

FIG. 7 shows the deadbolt mechanism 300 which drives the deadbolt 310. The bolts 220, 222 and 224 are coupled to motion of outside handle 110 by drive mechanism 440. To understand operation of the deadbolt mechanism it is useful to first understand operation of the drive mechanism.

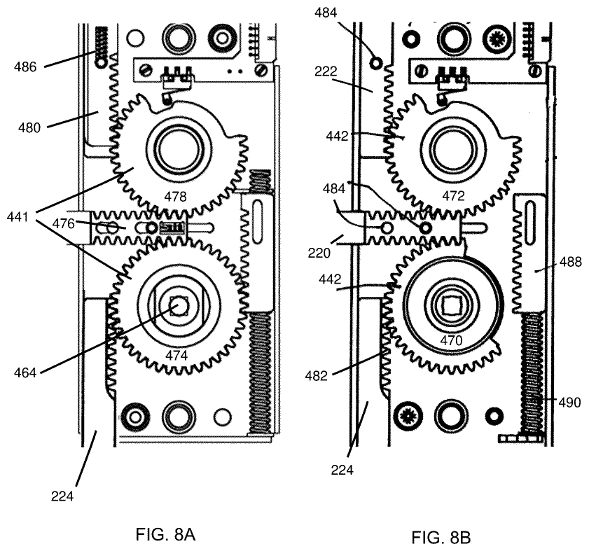

The drive mechanism 440 comprises a first drive train (largely not visible in FIG. 7). The drive mechanism may also couple to an inside handle 210 using a second drive train 441 shown in FIG. 7 which largely overlies the first drive train. In the arrangement of FIG. 7 both handles drive rotation around a same handle axis. The drive trains may be implemented in various ways, and may share common components with each other. In FIG. 7 the second drive train 441 can be seen but overlies most of the components of the first drive train. The first drive train is shown in FIG. 8B, with the second drive train shown for comparison in FIG. 8A. In FIG. 8B overlying components of the second drive train have been removed to reveal the first drive train 442. Referring to FIG. 8B, the first drive train 442 comprises a first gear 470 which is rotated by operation of the outside handle 110, typically connected to the first gear using a short shaft. The first gear 470 meshes directly with gear racks on the lower vertical bolt 224 and on the horizontal bolt 220 so as to retract or extend these bolts as the outer handle is operated (when released by mechanical code lock). Another gear rack on the upper side of the lateral bolt 220 in turn drives rotation of a second gear 472 which in turn meshes with a gear rack on the upper bolt 222 to drive retraction and extension of that upper bolt member.

In FIGS. 7 and 8A it can be seen that the second drive train 441 comprises a third gear 474, overlying and coaxial with the first gear 470, and which is rotated by operation of the inside handle 210, typically connected to the third gear 474 by a short shaft. The first and third gears are able to rotate independently, and are separately driven about a handle axis 464 by operation of the outside and inside handles respectively, although their motions are coupled at least through the lost motion coupling of the drive trains as discussed below.

The third gear 474 does not mesh with the lower bolt 224 (the teeth on lower bolt 224 are cutaway) or with the horizontal bolt 220. Instead, it meshes with a lower gear rack of a lateral lost motion member 476 which is adjacent to (and overlies from the perspective of FIG. 8A), and slides along, the horizontal bolt 220. The lateral lost motion member 476 also comprises an upper gear rack which meshes with a fourth gear 478 coaxial with (and from the perspective of FIG. 8A overlying) the second gear 472. The fourth gear 478 in turn meshes with a gear rack of an upper lost motion member 480 which slides along (and from the perspective of FIG. 8A overlies) the upper vertical bolt 222.

On operation of the inner handle 210 to drive retraction of the bolts through the second drive train 441, the lost motion members 476, 480 initially move for a limited, lost motion, distance without driving the adjacent or underlying bolt members. Once the lost motion distance has been covered, the lost motion members then engage and drive retraction of the adjacent upper vertical and horizontal bolts 222, 220. Retraction of the lower vertical bolt 224 is driven by lost motion being taken up between the rotation of third gear 474 and first gear 470, and the rotation of the third gear 474 causing rotation of the first gear which engages and drives gear rack 482 of lower vertical bolt 224. Motion of the driven upper bolt member 222 supports driving retraction of the horizontal bolt 220 through the second gear 472.

The above lost motion mechanisms may be implemented by providing the horizontal and upper vertical bolts with pins 484 which engage within, and slide along, corresponding slots 486 in the adjacent lateral and upper lost motion members 476, 480 or vice versa.

A sprung ancillary member 488 on the opposite side of the gears from the bolts may be provided, having a geared rack against which the side of the third gear 474 opposite to the lower vertical bolt 224 bears and meshes, and a compression spring 490 bearing on the ancillary member can thereby be used to urge the second drive train 441, and therefore also the first drive train 442 towards extension of the bolt members, in opposition to operation of the handles.

Operation or rotation of the inside and outside handles may be coupled to drive the bolts using first and second drive trains having configurations of elements which are different to those described above and shown in FIGS. 7-8.

As shown in FIGS. 3 and 7, the bolting mechanism comprises deadbolt mechanism 300. The deadbolt mechanism comprises deadbolt 310 arranged to prevent the bolts from being driven from the extended to the retracted configuration when the deadbolt is in a locked state. For example, the deadbolt 310 may prevent the bolts being driven from the extended configuration if pressure or force is applied to the ends of the bolts by a third party attempting to force entry into the building.

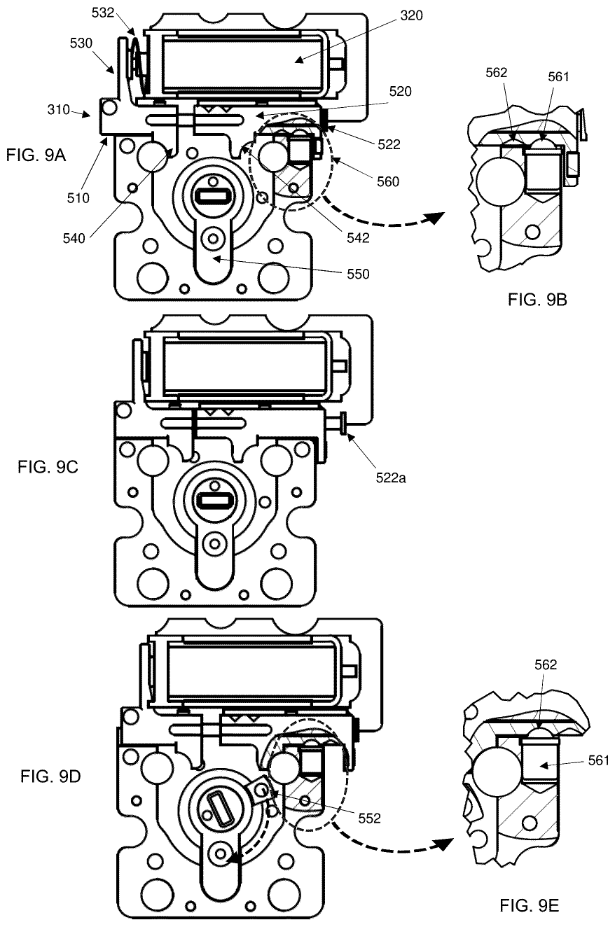

The deadbolt mechanism 300 is shown enlarged in FIG. 9. In comparison to the views of the deadbolt mechanism 300 in FIGS. 3 and 7, a plate or part or the housing of the deadbolt mechanism has been removed to reveal the internal workings of the mechanism.

As mentioned in the preceding paragraphs, the deadbolt 310 of the deadbolt mechanism 300 protrudes into a recess in the upper vertical bolt to block retraction of the bolt. The deadbolt mechanism may comprise an electrical actuator such as solenoid 320, a key cylinder driven barrel and the deadbolt itself. The deadbolt may have two parts or portions that although linked may move separately. In FIG. 9A the deadbolt can be seen to be a sliding deadbolt having a first portion that protrudes from the deadbolt mechanism. This portion is considered to be the locking portion 510 because the protruding end of the locking portion slides into the recess in the bolt blocking retraction of the bolt. The deadbolt further comprises a latch portion 520. The locking portion 510 and latch portion 520 together form an elongate sliding deadlock. The two portions are linked by rod or guide 522. A first end of the rod or guide 522 screws into or is otherwise fixed to the locking portion. The latch portion 520 has a hole through its length in which the rod or guide moves. The distal end of the rod of guide 522 includes a stopping face 522a, shown in FIG. 9C, which cannot pass through or into the hole in the latch portion 520. This arrangement allows the latch portion and locking portion to be moved slightly apart from each other limited by the length of the rod or guide.

The deadbolt further comprises a first transverse protrusion or first sidearm, such as drive fork 530, which projects transversely from the direction of the elongate deadbolt. The first protrusion projects from the locking portion of the deadbolt. The first protrusion projects to be driven by electrical actuator 320 which may be mounted at the top of the deadbolt mechanism as shown in FIG. 9A. The electrical actuator may have an actuation rod which is driven by the actuator and coupled to the first protrusion. The drive fork arrangement of the first protrusion is configured to receive and be coupled to the end of the actuation rod. For example, the end of the actuation rod may have a narrower portion which slots between the prongs of the drive fork. Other arrangements of coupling between the actuation rod and first protrusion are possible. The electrical actuator may be a solenoid or motor. In other embodiments the actuator may be driven by compressed gas or air. In the embodiment in which the actuator is a solenoid the actuation rod is moved by movement of the solenoid core. The solenoid is preferably configured such that when power is applied the core is retracted pulling the first protrusion towards the solenoid thereby retracting the deadbolt. However, alternatively the solenoid may be powered continuously and on removal of power the solenoid core is retracted. This is less preferred because it requires power is supplied most of the time. The electrical actuator may be connected to access control unit 150, such as shown in FIG. 2. On providing an authorised swipe card, or entering the correct code in to electronic key pad, a signal or voltage may be sent to the electrical actuator to retract the solenoid core to retract the deadbolt.

First transverse protrusion 530 may also provide a manual override to the deadbolt, which we will describe later. The locking portion of the deadbolt is biased to the thrown position by action of a spring such as coiled spring 532 or leaf spring between the first protrusion and solenoid mount, but other bias elements in other positions may be used. The latch portion may further comprise a third side arm or transverse protrusion 540 extending in the opposite direction to the drive fork, namely in the direction towards the key cylinder 140.

The latching portion 520 of the deadbolt also comprises a transverse protrusion 542. This second transverse protrusion or sidearm is provided for driving by a key cylinder. Key cylinder 550 is shown in the FIG. 9A. This may be the key cylinder 140 or may be a barrel extension that receive a tailpiece 142 of key cylinder 140 shown in FIG. 4B. On insertion of a matching key a release driver, which is preferably a cam or tang 552, shown in FIG. 9D, may be rotated. Key cylinder 550 may be more broadly implemented as a key driven actuator with a rotatable cam or tang 552. As shown in FIG. 9A and 9D, rotation of the key and cam 552 from a start position in which the cam is oriented downwards, the 6 o′clock position, in a clockwise direction, the cam will hit the second protrusion 542 at about the 1 o'clock position so following just over half a turn of the key in the key cylinder. Further driving of cam of the key cylinder will push further against the second transverse protrusion 542 to push the latch portion 520 pf the deadbolt back, thereby retracting the locking portion 510. Operation of the key cylinder to retract the deadbolt will be further described in the following. The latch portion 520 may be held in the retracted position by a latch 560. As shown in FIG. 9B which is an inset of FIG. 9A, the casing of the deadbolt mechanism may comprise a sprung ball or piston 561 and the latch portion 520 may comprise a recess or indent 562. When the latching portion is pulled back the sprung ball or piston is pushed into the recess holding the latch portion retracted.

We have previously mentioned a manual override of the deadbolt and lost motion member 480. Referring to FIG. 7 lost motion member 480 can be seen overlying upper vertical bolt 222. The manual override results from actuation of the inside handle 210 which operates on third gear 474. In more detail, the first transverse protrusion 530 on the locking portion 510 of the deadbolt may comprise an override member 531 which may take the form of a nose or extension, as shown in FIG. 7 (not shown in FIGS. 9A-9E). Lost motion member 480 comprises a cut out which aligns with the notch in the bolt into which the deadbolt moves to block motion of the bolt. The notch has square or right-angled sides such that if the bolt moves the deadbolt abuts against the sides of the notch. On the other hand the cut-out in lost motion member 480 has a sloped or inclined portion at its upper end to transition from the cut-out to full width of the lost motion member 480.

The manual override is driven by the inside handle 210 to allow free escape from the inside of a building or secure area, for example, in the event of an emergency. Turning of inside handle 210 rotates third gear 474, the meshing rack of which retracts the lost motion member 476 which overlies the horizontal bolt 220. The lost motion member 476 also has a rack on its upper edge, the retraction of which rotates fourth gear 478. Lost motion member 480 overlying the upper vertical bolt is pulled downwards by the meshing of gear 478 which engages rack of lost motion member 480. As the lost motion member 480 is pulled downwards the inclined portion of cutout slides against the override member 531 of first transverse protrusion. As the inclined portion moves further downward the incline pushes further against the override member 531 pushing it backwards. The connection between the override member 531, via the first transverse protrusion, to the deadbolt, causes retraction of the deadbolt. When the lost motion member 480 is fully moved downwards, the override member is fully pushed in by the incline and the deadbolt is retracted from the path of the bolt. Further turning of the inside handle 210 turns the third gear 474 which takes up lost motion between various components as described earlier, and retracts the horizontal bolt 220. The retraction of the horizontal bolt 220 further turns the second and fourth gears retracting the upper vertical bolt. The lower vertical bolt is also retracted by turning of the third and first gears.

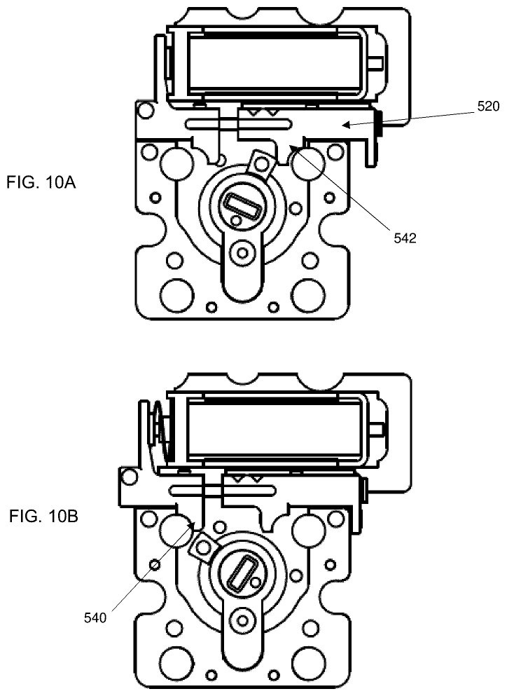

We now describe in further detail operation of the deadbolt mechanism as shown in FIGS. 9A-9E and 10A-10B.

In FIG. 9A the deadbolt is thrown and the tang or cam of key cylinder is in the rest or parked position at 6 o'clock (not shown). In FIG. 9C the deadbolt 310 has been retracted either by operation of the manual override including override member 531 or by retraction by the electrical actuator 320 which may be a solenoid. The retraction of the deadbolt is actually retraction of the locking portion of the deadbolt 510. The position of the latching portion 520 of the deadbolt is unchanged. In FIG. 9D, the deadbolt has instead been retracted by rotation of the cam 552 of the key cylinder. To arrive at this positioning the cam of the key cylinder is turned from the rest or start position in FIG. 9A in which also the locking portion 510 of the deadbolt is thrown. The cam 552 of the key cylinder is rotated in the clockwise direction and the cam hits the sidearm or second transverse protrusion 542 of latching portion 520 of the deadbolt shortly after half a rotation. Continued turning of the key cylinder and key cam 552 pushes further against the sidearm retracting the latch portion and even further turning pulls the locking portion with the latch portion to retract the locking portion of the deadbolt as shown in FIG. 9D. To release the key from the key cylinder, the key cam can be turned the full 360 degrees to return the cam 552 to the start or rest position. In the position in FIG. 9D the deadbolt is latched in the retracted position by the detent arrangement described previously. The sprung ball 561 engages in recess or indent 562 of the latching portion 520 of deadbolt as best shown in FIG. 9E which is an inset of FIG. 9D.

FIGS. 10A and 10B show an alternative operation for retracting the deadbolt using the key cylinder but that does not latch the sliding deadbolt in the retracted position. In FIG. 10A the cam of the key cylinder has been rotated similarly to FIG. 9D to pull back both portions of the deadbolt. However, the cam does not fully push back the latching portion of the deadbolt so that it does not latch. However, if the key is maintained in this position for long enough to turn the handle 110, then entry through the door may be allowed. The key and key cam may then be rotated back in the anti-clockwise direction towards the start or rest position. On the way the cam of key cylinder will push third sidearm or transverse protrusion 540 out of its path and in doing so will move the deadbolt to the thrown position as shown in FIG. 10B. The key and cam can then be returned to the start or rest position by continued anti-clockwise rotation of the key and cam. Further retractions of the deadbolt may be by any of the described methods, namely by mechanical override, use of the electrical actuator or turning of the key cylinder 140.

The combination of the various features provides a bolting mechanism that controls access by electrical means or by mechanical means, for example, if it is desired to switch off the electrical supply.

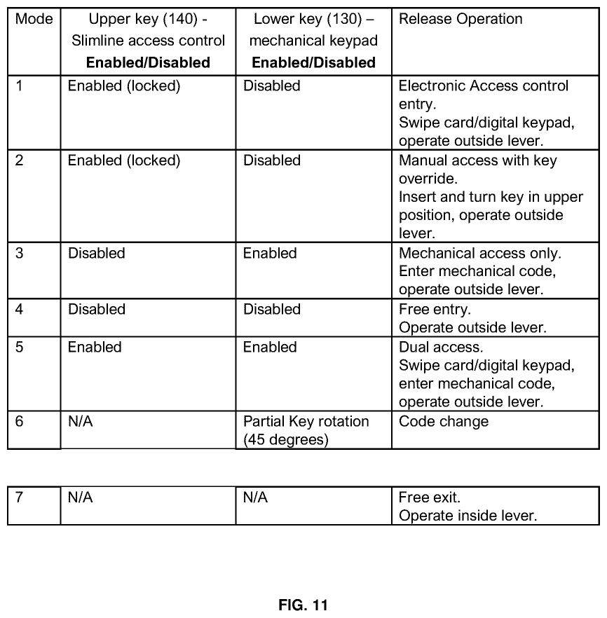

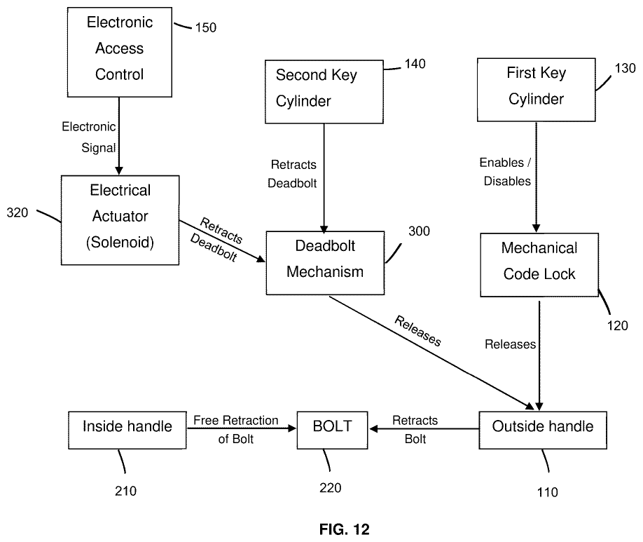

FIGS. 11 and 12 are respectively a table summarizing the various operating modes of the bolting mechanism and a flow chart summarizing operation of the bolting mechanism. The various operating modes are set by the rotation of the upper and lower key cylinders 130, 140.

As shown in FIG. 11 there are seven modes of operation of the bolting mechanism. Six modes are from the outside, and one mode is from the inside and requires operation of the inside handle or lever. Of the six outside modes, one mode is not an access mode but a code change mode. The other outside modes are completed by operating the outside handle or lever. The seventh mode in the table indicates that whatever the positioning or modes set by the upper and lower key cylinders 130, 140, it is always possible to exit from the building by operating the inside lever or handle 210. This seventh mode uses the manual override operation.

Of the six outside modes of operation shown in the table of FIG. 11, the first has the upper key cylinder 140 in the rest or locked position with the deadbolt thrown. The lower ley cylinder 130 is in the disabled configuration, as described in relation to FIG. 4C, with the mechanical code lock deactivated. In this mode, power is supplied to electronic access control and electrical actuator. The deadbolt is retracted and access gained using the electronic access control unit 150, such as by a swipe card or entering the correct code to the electronic key pad. After retracting the deadbolt the outside handle may be operated and entry gained.

The second mode of operation is by using a matching key 141 with the upper key cylinder 140. Rotation of the key cylinder manually retracts the deadbolt, as described in relation to FIGS. 9D and 10A-10B. After rotation of the key, the outside handle may be operated and entry gained.

The third mode of operation has the lower key cylinder 130 in the enabled configuration such that the mechanical key pad, as described in relation to FIG. 6A, is in operation. The upper key cylinder is disabled such that the deadbolt is retracted, as described in relation to FIG. 9D, and latched in the retracted position. Access is gained by entry of the correct code into the key pad of the mechanical code lock 120, followed by turning the outside handle. This method of access control requires no power is supplied.

The fourth mode has the upper and lower key cylinders in their disabled positions such that the deadbolt is retracted and the mechanical key pad is inactive. Here there is no barrier to entry which is by turning the outside handle.

The fifth mode is opposite to the fourth mode and has the upper and lower cylinders 130, 140 in their enabled configurations. Here the deadbolt is thrown and the mechanical code lock is active. Hence, access is obtained by entering the correct code into the key pad of the mechanical key code lock and at the same time providing a swipe card to the access control device or entering the correct code into the electronic access control device. Both forms of access control (mechanical and electrical) are active and both will need to be released, after which the outside handle may be turned to gain entry.

The sixth mode is the code change mode for the mechanical code lock. This mode may be operated whatever positioning the upper key cylinder takes, whereas careful positioning of the lower key cylinder is required. To enter the sixth mode the lower key cylinder is rotated 45 degrees anti-clockwise to the position shown in FIG. 6B, upon which the change in code process can be performed.

Accordingly, among the various modes the first mode provides a high level of access control using the electronic access control (swipe card or numeric digital code required), whereas the third mode also provides a high level of access control using the mechanical access control (code for mechanical code lock).

The flow chart of FIG. 12 links the various operations of the bolting mechanism. As can be seen the inside handle operates on the bolts to retract the bolts. The inside handle operates freely to always allow exit from the building. Operation of the outside handle is controlled by the deadbolt mechanism 300 and the mechanical key code lock 120, each of which is required to be released to allow the outside handle to be turned. The mechanical code lock may be disabled and enabled by the first/lower key cylinder 130. As discussed, when enabled a correct code must be entered on the key pad to allow release of the outside handle. Alternatively, the mechanical code lock can be disabled by the lower key cylinder. In both cases, the outside handle will only be released if the deadbolt mechanism is also released. The deadbolt mechanism can be released by the manual override provided by rotation of the second key cylinder 140, as described in relation to FIGS. 9D and 10A-10B. Alternatively, the deadbolt mechanism can be released by the electronic access control by swipe of a card or entry of the correct code on the electronic key pad of the electronic access device 150. The electronic access control sends a signal to the electrical actuator to move the solenoid core to retract the deadbolt.

Accordingly, by selection of the operating mode using the first and second key cylinders, the bolting mechanism can be switched from access control that requires power to enable the electronic access control, to mechanical access control provided by the mechanical key code lock. In both instances override is also provided by the second key cylinder.

In a further aspect of the present invention the mechanical key code lock with first key cylinder may be provided together but without the second key cylinder or the deadbolt mechanism. Such an arrangement would provide a mechanical key code lock that could disabled by operation of the first key cylinder or enabled to require input of the key code on the push button key pad of the mechanical key code lock.

In a yet further aspect of the present invention the deadbolt mechanism may be provided without the mechanical key code lock and first key cylinder. The deadbolt mechanism could be incorporated into a drive mechanism as described hereinto provide electronic access control or manual override by the second key cylinder. Alternatively, the deadbolt mechanism may be used on its own to secure doors or leaves preventing access therein, or provided as part of locking assembly in which the deadbolt mechanism provides a deadbolt action on a bolt.

The person skilled in the art will readily appreciate that various modifications and alterations may be made to the above described bolting mechanism. The modifications may be made without departing from the scope of the appended claims. For example, the first and second key cylinders may be positioned differently. The gears of the drive mechanism may be configured differently such as without teeth but to drive each other by lever action or the use of a belt or chain. The solenoid may be replaced with a motor such as a worm drive motor providing linear movement in a similar manner to the solenoid. Furthermore, variations in the actual shapes of the parts such as the sliding deadbolt, cams, and bolt may be made without diverging from the general scope of the present invention.

What is claimed:

1-22. (canceled)

23. A bolting mechanism comprising:

24. a bolt movable between a thrown position and a retracted position;
a drive mechanism configured for retracting the bolt, the drive mechanism configured to be driven by a first handle from a first side;
a mechanical code lock having a key pad for receiving an entry code; and
a first key actuated controller configured to enable and disable the mechanical code lock such that when the mechanical code lock is enabled the mechanical code lock, on entry of a matching code to the key pad, enables actuation of the drive mechanism by the first handle;
a deadbolt mechanism comprising a deadbolt arranged to prevent the bolt from being driven by the first handle when the deadbolt is in the locked state, the deadbolt mechanism comprising:
an electrical actuator configured to release the deadbolt from the locked state when a release signal is received from an electrical access control unit; and
a second key actuated controller configured to release the deadbolt from the locked state on actuation by a matching key, wherein the drive mechanism is configured such that, when enabled by the mechanical code lock, and the deadbolt is released by the deadbolt mechanism, the first handle is released for driving the bolt to the retracted position.

25. The bolting mechanism of claim 23, wherein the drive mechanism has a second side configured to receive a second handle, the drive mechanism configured to be driven by the second lever/handle to override the deadbolt and drive the bolt to the retracted position.

26. The bolting mechanism of claim 24, wherein the first side from which the drive mechanism is configured to be driven by a first handle is configured to be on a first side of a door or leaf, and the drive mechanism is configured to be driven by the second handle from a second side is configured to be on a second, opposing side of the door or leaf.

27. The bolting mechanism of claim 23, wherein the first key actuated controller and the second key actuated controller are configured to receive mechanical keys at the first side of the drive mechanism, and the mechanical code lock is arranged to receive entries on the key pad at the first side of the drive mechanism.

28. The bolting mechanism of claim 23, wherein the first key actuated controller and second key actuated controller are key cylinders.

29. The bolting mechanism of claim 23, wherein the key pad is located at the first side of the drive mechanism between the first key actuated controller and the second key actuated controller.

30. The bolting mechanism of claim 23, wherein the first key actuated controller is configured to enable a code change mode on the mechanical code lock for changing the code enabling actuation of the drive mechanism by the first handle, the code change mode enabled on receiving and rotating a matching key.

31. The bolting mechanism of claim 29, wherein the first key actuated controller comprises a first key cylinder, the bolting mechanism further comprising:
an activation plate configured to slide between an activated position in which the key pad is active for receiving input of an entry code and operably releasing the first handle, and an inactive position in which the key pad is decoupled from control of the handle; and
a cam coupled to the first key cylinder, the cam configured such that on receipt and rotation of a matching key by the first key cylinder the cam drives the activation plate between the activated position and inactive position.

32. The bolting mechanism of claim 30, wherein the cam is configured for rotation to a change position enabling the change code mode in which the cam pushes against a change member enabling changing of the correct entry code for the key pad.

33. The bolting mechanism of claim 23, wherein:
the second key actuated controller comprises a second key cylinder; and
the deadbolt of the deadbolt mechanism is a sliding deadbolt configured to slide between a locked position in which the sliding deadbolt inhibits retraction of the bolt and one or more unlocked positions.

34. The bolting mechanism of claim 32, wherein the electrical actuator of the deadbolt mechanism is configured to retract the sliding deadbolt to one of the one or more unlocked positions on application or removal of power to the electrical actuator.

35. The bolting mechanism of claim 32, wherein the deadbolt mechanism further comprises:
a release driver arranged such that, when driven by the second key cylinder, the release driver retracts the sliding deadbolt to one of the one or more unlocked positions; and
a latch configured to hold the sliding deadbolt in one of the one or more unlocked positions until the release driver is further driven by the key cylinder to release the sliding deadbolt.

36. The bolting mechanism of claim 34, wherein the release driver is a rotatable cam or tang of the second key cylinder.

37. The bolting mechanism of claim 34, wherein the sliding deadbolt comprises a locking portion configured for inhibiting retraction of the bolt and a latch portion configured to be held by the latch in the one of the one or more unlocked positions, the latch portion slidable with lost motion relative to the locking portion.

38. The bolting mechanism of claim 36, wherein:
the electrical actuator is configured to retract the locking portion of the sliding deadbolt to a first of the one or more unlocked positions;
a release driver arranged such that, when driven by the second key cylinder, the release driver retracts the latch portion of the sliding deadbolt to the first or a second of the one or more unlocked positions; and
the latch configured to hold the latch portion of the sliding deadbolt in the second of the one or more unlocked positions until the release driver is further driven by the key cylinder to release the sliding deadbolt.

39. A bolting mechanism kit, comprising the bolting mechanism of claim 23 and further comprising an electrical or electronic access control device configured for mounting on or next to the first side of the door or leaf.

40. A bolting mechanism comprising:
a bolt movable between a thrown position and a retracted position;
a drive mechanism configured for retracting the bolt, the drive mechanism configured to be driven by a first handle from a first side;
a mechanical lock configured for releasing and preventing retraction of the bolt;
an electrically activated lock configured for releasing and preventing retraction of the bolt; and
one or more mechanical controllers configured to select whether the mechanical lock is configured for release and whether the electrically activated lock is configured for release, the one or more mechanical controllers operable to select on provision of a secure key.

41. A code lock for controlling access through a door or leaf, the code lock configured to be inactivated on action of a key cylinder, the code lock comprising:
a key pad for receiving an entry code;
a handle for retracting a bolt or latch of the door or leaf, the handle configured to be operable upon entry of the correct entry code to the key pad;
the key cylinder;
an activation plate configured to slide between an activated position in which the key pad is active for receiving input of an entry code and operably releasing the handle, and an inactive position in which the key pad is decoupled from control of the handle; and
a cam coupled to the key cylinder, the cam configured such that on receipt and rotation of a matching key by the key cylinder the cam drives the activation plate between the activated position and the inactive position.

42. The code lock of claim 40, wherein the cam is configured for rotation to a change position in which the cam pushes against a change member enabling changing of the correct entry code for the key pad.

43. A lock mechanism, comprising:
a bolt movable between a thrown position and a retracted position; and
a deadbolt mechanism comprising:
a sliding deadbolt configured to slide between a locked position in which the sliding deadbolt inhibits retraction of the bolt and one or more unlocked positions;
an electrical actuator configured to retract the sliding deadbolt to one of the one or more unlocked positions on application or removal of power to the electrical actuator;
a release driver arranged such that, when driven by a key cylinder, the release driver retracts the sliding deadbolt to one of the one or more unlocked positions; and
a latch configured to hold the sliding deadbolt in one of the one or more unlocked positions until the release driver is further driven by the key cylinder to release the sliding deadbolt.

44. The lock mechanism of claim 42, wherein the sliding deadbolt comprises a locking portion configured for inhibiting retraction of the bolt and a latch portion configured to be held by a latch in one of the one or more unlocked positions, the latch portion slidable with lost motion relative to the locking portion.

45. The lock mechanism of claim 42, wherein the release driver is a tang or cam of the key cylinder.
